(19) United States
(12) Patent Application Publication
(10) Pub. No.: US 2015/0248372 A1
(43) Pub. Date: Sep. 3, 2015

(54) MODULAR BUS SYSTEM FOR DATA AND/OR ENERGY TRANSMISSION

(71) Applicant: PHOENIX CONTACT GMBH & CO.KG, Blomberg (DE)

(72) Inventor: Karsten Meyer-Graefe, Schloss Holte-Stukenbrock (DE)

(21) Appl. No.: 14/437,135

(22) PCT Filed: Oct. 24, 2013
(86) PCT No.: PCT/EP2013/072310

§ 371 Date: Apr. 20, 2015

(30) Foreign Application Priority Data
Oct. 24, 2012 (DE) 10 2012 110 170.1

(51) Int. Cl. G06F 13/42; G06F 1/26

(52) U.S. Cl. CPC G06F 13/4282; G06F 1/266

(57) ABSTRACT

A modular bus system for data and/or power transfer, which comprises at least two bus subscribers that can be placed side by side. Each bus subscriber comprises a housing having a plurality of walls. In or on a first wall of the housing, an antenna is arranged which defines a geometrical area which has an area ratio to the surface area of the first wall of at least 0.5. The bus subscribers are electrically coupled to each other by having an antenna of each bus subscriber electromagnetically coupled to an antenna of another bus subscriber, for transferring data and/or power. The first walls of bus subscribers that are electrically coupled to each other are arranged approximately in parallel to each other.

### FIELD OF THE INVENTION

The invention relates to a modular bus system for data and/or power transfer, and also relates to a bus subscriber for use in such modular bus system.

### BACKGROUND OF THE INVENTION

Systems in which electronic modules such as measuring devices, automation modules, or control devices can be arranged and which enable electrical power supply of the electronic modules and communication via a radio link are known from prior art.

However, the prior art systems may be problematic because the efficiency of the wireless power transfer is not sufficient, so that the transferred power is subject to rather narrow limits.

### SUMMARY OF THE INVENTION

The invention is based on the object to provide for a more efficient wireless power transfer to subscriber devices of a bus system.

One aspect of the invention relates to a modular bus system for data and/or power transfer, wherein the bus system comprises at least two bus subscribers that can be placed side by side. In the present context ‘side by side’ means that the bus subscribers can be arranged directly adjacent to each other or spaced from each other.

Another aspect of the invention relates to a bus subscriber for use in a modular bus system for data and/or power transfer.

The bus subscriber or each bus subscriber may comprise a housing having a plurality of walls. An electronic circuit or an electronic module is arranged or arrangeable in the housing. Alternatively, the bus subscriber may be adapted to be coupled to an electronic module.

The housing may comprise pairs of walls that are substantially parallel to each other, and may optionally have a substantially parallelepipedal shape. The housing may also have a shape in which the pairs of walls are obliquely or non-parallel to each other.

The bus subscribers may be arranged or arrangeable side by side, so that the first bus subscriber and a last bus subscriber each has one immediate neighbor and each of the other bus subscribers has two immediate neighbors.

In or on a first wall of the housing at least one antenna may be arranged. Here, the first wall does not define a specific order of the walls but refers to that wall in which or on which the antenna is arranged. The first wall may be considered as an antenna wall.

Each of the bus subscribers may be electrically coupled to its immediate neighbor(s) by having an antenna of each bus subscriber electromagnetically coupled to an antenna of its immediate neighbor(s).

Each of the bus subscribers may be arranged or arrangeable on a support rail which is preferably in form of a hat rail in which, optionally, an electrical line is arranged. A power supply module may preferably be coupled to or may be adapted for being coupled to the electrical line, for example galvanically, in particular by means of a T-connector, or optionally inductively or capacitively.

Each of the bus subscribers may be adapted for being mechanically coupled to the support rail by a plug-in connection.

Optionally, the first bus subscriber may be the same as the last bus subscriber, so that the bus has a ring topology.

The bus system is referred to as modular. Here, “modular” may mean that the bus subscriber can be inserted into the bus system and removed from the bus system without thereby affecting or impairing the functionality of the bus system. “Modular” may further mean that the functionality of the bus subscriber can be expanded using expansion cards, so that the bus subscriber does not have to be equipped with all functionality already in the manufacturing stage.

The antenna of the bus subscriber may have a geometric antenna area.

In case of a substantially two-dimensional antenna which is for example arranged in a plane of the wall, with dimensions perpendicular to the plane substantially smaller than the dimensions along the plane, the geometric antenna area may be regarded as the surface area delimited by an outer contour of the antenna. Such an antenna may be a thin wound antenna, or a printed antenna, or a planar antenna implemented in stripline technology, e.g. a patch antenna, or a stripline slot antenna.

In case of an antenna that has dimensions perpendicular to the wall which are not negligible, such as a coil having turns arranged along a longitudinal axis, the geometric antenna area is disposed in a wall surface which is delimited by an outer contour of a projection of the antenna onto the wall surface.

The geometric antenna area may be related to the surface of the first wall defining an area ratio. The area ratio may be considered as a mathematical quotient of the antenna area to the surface of the first wall, or antenna wall. The area ratio may have a value of at least 0.5, or for example at least 0.6, 0.7, or 0.8. This ensures that the power transfer between the bus subscribers is less sensitive to an inaccurate alignment of the bus subscribers with respect to each other.

The bus subscriber may be adapted for being electrically coupled to at least one further bus subscriber by electromagnetically coupling an antenna of the bus subscriber with an antenna of the further bus subscriber, for data and/or power transfer.

The first walls of bus subscribers that are electrically coupled to each other may be arranged approximately in parallel to each other.

The described features of the bus system and of the bus subscriber are very beneficial.

The high area ratio of the antennas, the parallel arrangement of the first walls, and the aligned antennas provide for an efficient transfer of electromagnetic radiation between the antennas of the bus subscribers involved and for a transfer of high electromagnetic powers.

The use of antennas that are disposed in or on a wall, allows a space-saving arrangement for supplying the bus subscribers with electrical energy, because a use of conventional transformers can be avoided in this manner.

Thus, the advantages include:
space and cost savings in the implementation of the electronic module;
galvanic isolation of the electronic module; and
simplification and increased efficiency of the power supply of the electronic module.

Advantageous embodiments and modifications will now be described below. The features of the embodiments may be combined with one another and with each of the aspects of the invention, as far as technologically feasible.

According to one embodiment, the bus system may comprise a supply module for feeding electrical power and/or data to the bus subscribers or to electronic modules associated therewith or to the bus. The supply module may be configured as a first bus subscriber.

The electromagnetic energy may be transferred in a transfer chain from one bus subscriber to the next one, i.e. from the supply module to the first bus subscriber, from the first bus subscriber to the second bus subscriber, and so on. The transfer chain may constitute or define the bus.

The electromagnetic energy may likewise be transferred in a star topology from one bus subscriber to a plurality of bus subscribers, for example at least two, three, four, or five bus subscribers. For example, the electromagnetic radiation from the first bus subscriber may be received by all or at least part of the bus subscribers.

The supply module may comprise means for signal processing or signal amplification or signal regeneration. Advantageously, this allows to process a signal fed into the bus system from outside.

Particularly advantageously, this further allows for a signal from the supply module within the bus system to be received, processed, and relayed in the bus system, i.e. to be transferred to a further bus subscriber.

Such signal processing permits to compensate for losses along the bus transfer path.

The supply module may be connected to a mains voltage, which preferably is about 220 or 110 volts and has a frequency of about 50 or 60 Hz.

According to one embodiment, the antenna may be provided in form of a spiral antenna, a circular antenna, a coil, or a capacitive plate.

With regard to manufacturing technology, the antenna may be formed as a molded interconnect device (MID), or inlay, or as an overmolded antenna, or a thin wound or printed antenna, or an adhesive antenna.

Alternatively, the antenna may be a planar antenna implemented in stripline technology, for example a patch antenna or a stripline slot antenna. Such antennas are in particular contemplated for transferring data signals.

The antenna may be arranged on a foil which is attached to the first wall. This embodiment advantageously provides for an efficient and low-cost installation/removal or replacement of the antenna.

According to one embodiment, a minimum value of the area ratio may be 0.7, or preferably 0.8, or in particular 0.9.

The antenna may extend over the entire surface of the wall. In this case, the area ratio is equal to or approximately equal to 1.

According to one embodiment, the antenna of a bus subscriber may have a number of turns which depends on the distance of the bus subscriber to the supply module, which distance is measured as the number of intermediary bus subscribers.

The antenna of a bus subscriber that has a distance to the supply module which is greater than the distance of a second bus subscriber to the supply module may have a number of turns that is greater than the number of turns of the antenna of the second bus subscriber, in order to compensate for losses, in particular transfer losses or losses in the electronic circuits of the bus subscribers.

According to one embodiment, the housing of at least some of the bus subscribers may have a further antenna arranged in a second wall thereof. Here, the second wall does not define a specific order among the walls but rather refers to a further wall in addition to the first wall, in or on which the antenna is arranged. That means, a respective antenna or, if appropriate, multiple antennas may be arranged on or in two, three, four, five, or more walls.

The first and/or the second wall of the housing of at least some of the bus subscribers may have a plurality of antennas arranged therein.

Data and power may be transferable via different antennas, or optionally via one antenna. Advantageously, this allows to adapt the antenna parameters, such as size or manufacturing technology, to the parameters of the signal to be transferred, such as frequency or power.

According to one embodiment, an electronic circuit or an electronic module may be arranged in the housing of each bus subscriber. The electronic module may in particular be a measuring device, an automation module, or a control device.

According to one embodiment, each bus subscriber may be configured as an adapter for being connected to an electronic module. Each adapter may be configured for data and/or power transfer. Thus, the adapter complements the modular concept of the bus system, according to which a bus subscriber or an electronic module can be easily inserted into the bus system and removed from the bus system.

The adapter may be configured for being connected mechanically and electrically to a support rail and to the electronic module. In a connected state of the adapter, for example when plugged or attached to the support rail, the adapter may be considered as an intermediate member which connects the support rail with the electronic module.

In another embodiment, the electronic module may be plugged to the support rail or placed on the support rail, and the adapter may preferably be placed on the electronic module or may be otherwise connected therewith.

The adapter may comprise a first fastening means for mechanical attachment to the support rail, by means of which the adapter may be mechanically fastened to the support rail and released therefrom. If the support rail carries electrical lines, the adapter can also be connected to the lines.

The adapter may comprise a second fastening means for mechanical attachment to the electronic module. In particular if it functions as an intermediate member between the support rail and the electronic module, the second fastening means provides for a corresponding connection.

The second fastening means may imitate a shape of the support rail, so that the electronic module can be mechanically fixed to the adapter in a similar manner as to the support rail. The adapter advantageously allows for a flexible use of the electronic module, which selectively may be connected to the support rail either directly or via the adapter, without requiring any modifications to the electronic module.

The electronic module may be adapted for being mechanically and/or electrically coupled to the adapter by a plug-in connection.

The electrical coupling between the electronic module and the adapter may be implemented galvanically, preferably by terminal points. Alternatively, the electronic module may be adapted for being electromagnetically coupled to the adapter, for example inductively or capacitively, for data and/or power transfer.

The adapter may comprise means for regenerating or amplifying an electrical signal, which signal may comprise a data signal and/or a power supply signal.

The adapter may be electromagnetically shielded from the electronic module to prevent electromagnetic interference in the electronic module. For this purpose, the adapter may be wrapped in a metal foil, at least in a region near the connection to the electronic module, which electrical connection between the adapter and the electronic module may be implemented using pins.

According to one embodiment, the bus subscriber may be configured as an adapter for being connected to the electronic module. Alternatively, the bus subscriber may be configured as an electronic module.

In order to prevent crosstalk from one antenna to another antenna in a bus subscriber or between adjacent bus subscribers, a shielding means may be provided in the housing of one bus subscriber.

The invention will now be explained in more detail by way of exemplary embodiments and with reference to the drawings wherein the same reference numerals designate the same or equivalent elements. The features of different exemplary embodiments may be combined with each other and with any aspect of the invention, as far as technologically feasible.

### BRIEF DESCRIPTION OF THE FIGURES

In the drawings:

FIG. 1 shows a bus system according to a first embodiment;

FIG. 2a shows a bus subscriber having one antenna according to a first embodiment;

FIG. 2b shows a bus subscriber having two antennas according to a second embodiment;

FIG. 3a shows an adapter according to a first embodiment;

FIG. 3b shows an arrangement of adapter and electronic module;

FIG. 3c shows an adapter according to a second embodiment;

FIGS. 3d-3g illustrate arrangements including an adapter and an electronic module;

FIG. 4 shows a bus system according to a second embodiment; and

FIG. 5 is a cross-sectional view of a bus subscriber having two antennas which are decoupled by a shielding.

### DETAILED DESCRIPTION

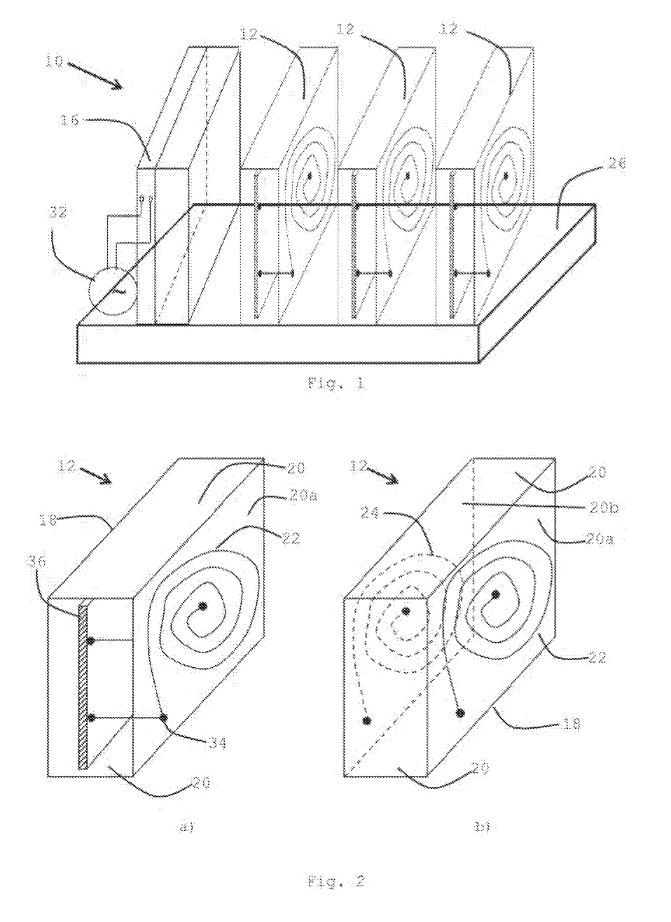

FIG. 1 shows an exemplary modular bus system 10 for data and power transfer. Bus system 10 comprises for example four bus subscribers 12 which are placed side by side, optionally with a respective spacing therebetween. Each bus subscriber 12 comprises a housing 18 having a plurality of walls 20, as illustrated in FIG. 2a.

A first wall 20a of housing 18 has an antenna 22 disposed thereon, which antenna defines a geometrical antenna area which has an area ratio of a value of about 0.7 to the surface area of the first wall 20a.

The bus subscribers 12 are electrically coupled to each other by having an antenna 22 of each bus subscriber 12 electromagnetically coupled to an antenna 22 of a further bus subscriber 12, for data and power transfer.

The first walls 20a of bus subscribers 12 that are electrically coupled to each other, are arranged approximately in parallel to each other.

The bus system 10 comprises a supply module 16 for feeding electrical power and data, which supply module 16 is configured as a first bus subscriber.

Supply module 16 is connected to a mains voltage 32 which is about 220 V and has a frequency of about 50 Hz.

The bus subscribers 12 including the supply module 16 are releasably fastened to a support rail 26.

FIG. 2a shows a bus subscriber 12 according to a first embodiment. Bus subscriber 12 comprises a housing 18 having a plurality of walls 20. The housing 18 substantially has a parallelepipedal shape, with pairs of walls 20 substantially parallel to each other. Housing 18 has an electronic circuit 36 arranged therein, which is indicated in the illustrated example in form of a circuit board.

A first wall 20a of housing 18 has a spiral antenna 22 disposed therein, which is implemented as a molded interconnect device (MID).

The bus subscriber 12 is electrically coupled to its immediate neighbor(s) 12 by having its antenna 22 electromagnetically coupled to an antenna 22 of its immediate neighbor(s) 12, for data and power transfer.

FIG. 2b shows a bus subscriber 12 according to a second embodiment. This embodiment differs from the first embodiment shown in FIG. 2a in that the bus subscriber 12 comprises a further antenna 24 in addition to the first antenna 22. The walls on which the two antennas 22, 24 are disposed, i.e. antenna walls 20a, 20b, are approximately in parallel to each other. The two antennas 22, 24 are aligned to each other, therefore electromagnetic coupling of antennas 22, 24 is very good.

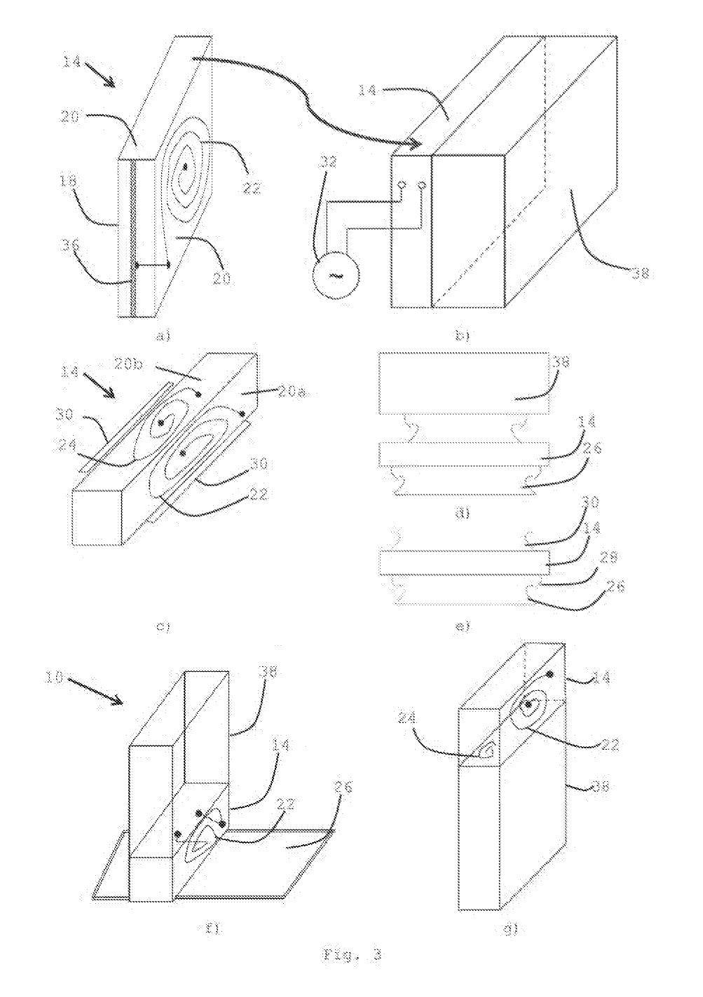

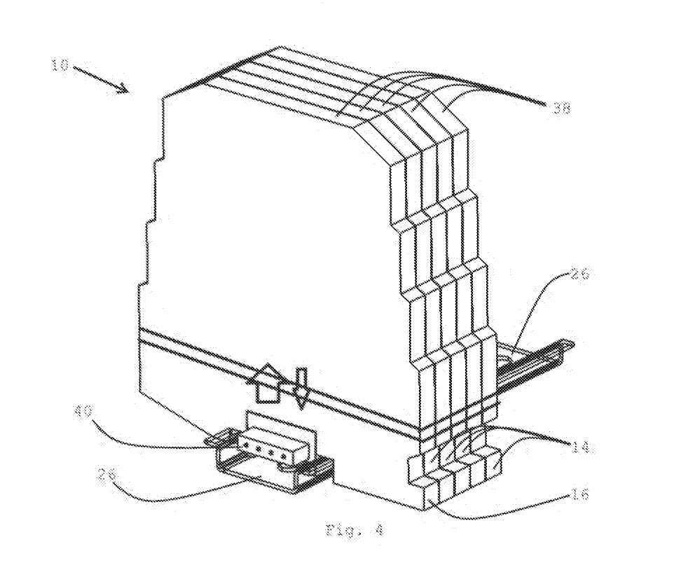

FIG. 3a shows an adapter 14 configured as a bus subscriber 12 according to a first embodiment. Adapter 14 is configured for being connected to an electronic module 38 and is configured for transferring data and power between the electronic module 38 and the bus.

In the present case, the bus is implemented as a chain-like communication link from a bus subscriber 12 to its single or two immediate neighbor(s) 12.

The adapter 14 comprises an electronic circuit 36 and an antenna 22. As shown in FIG. 3b, adapter 14 is mechanically coupled laterally to an electronic module 38 which is for example configured as a control device or a measuring device. Adapter 14 transfers data and power to the electronic module 38 via a galvanic or electromagnetic coupling (not shown).

By means of its antenna 22, the adapter 14 of FIG. 3b which is configured as a supply module transfers power to the antennas 22 of its neighbors (not shown in this figure).

FIG. 3c shows an adapter 14 having two antennas 22, 24. The first antenna 22 is disposed at a first wall 20a, the second antenna 24 is disposed at a further wall 20b. Antenna walls 20a, 20b are approximately perpendicular to each other.

First antenna 22 of antenna wall 20a which is arranged approximately in parallel to the antenna walls of adjacent adapters (not shown in this figure) serves to transfer data and power between the adapter 14 and
its neighbors, i.e. adjacent adapters; and
electronic modules 38 as shown in FIGS. 3f, 3g which are coupled to the adapter 14.

Between the second antenna 24 of adapter 14 and the antennas of electronic modules 38 (not shown) data and power transfer is accomplished. The antenna wall 20b of adapter 14 is disposed approximately in parallel to the antenna walls of the electronic modules 38 to which the adapter 14 is coupled.

FIGS. 3f, 3g show two alternative arrangements of adapter 14 and electronic module 38. According to FIG. 3f, the adapter 14 is placed on support rail 26 and the electronic module 38 is placed on adapter 14, so that the adapter 14 is arranged between support rail 26 and electronic module 38. According to FIG. 3g, the electronic module 38 is placed on the support rail 26 and the adapter 14 is placed on the electronic module 38. In both cases, adapter 14 and electronic module 38 are arranged one upon the other and are galvanically coupled to each other.

If the adapter 14 is disposed on the electronic module (FIG. 3g) it may comprise terminal points, similarly to an inline system, so that a direct connection of signal lines 40 arranged in the hat rail (see FIG. 4) is implemented. Alternatively, the adapter is arranged between electronic module 38 and the connection to the periphery (terminal or connector level) (FIG. 3f). Instead of or in addition to an antenna, the adapter 14 may comprise a plug-in connector. This makes it possible even for bus subscribers which do not have an inductive interface to be connected to the adapter 14.

FIGS. 3d, 3e show alternative embodiments of adapters 14 that are adapted to be connected to the support rail 26 and/or to the electronic module 38.

According to FIG. 3e, the adapter 14 has a first fastening means 28 for mechanical fixation to the support rail 26 and a second fastening means 30 for mechanical fixation to the electronic module 38 (not shown in FIG. 3e). The second fastening means 30 imitates a shape of the support rail 26, so that the electronic module 38 can be fastened to the adapter 14 in a similar manner as to the support rail 26. This shape of the support rail can be seen in FIG. 4.

Referring to FIG. 3d, adapter 14 and support rail 26 of FIG. 3e are shown together with electronic module 38.

FIG. 4 shows a second embodiment of the modular bus system 10 for data and power transfer. Bus system 10 comprises five bus subscribers in form of adapters 14 placed directly side by side. Adapters 14 are arranged on a support rail in form of a hat rail 26. Each adapter 14 has an electronic module 38 arranged thereon.

The vertical arrows illustrated in this figure represent the transfer of data and power between adapter 14 and electronic module 38. The thick arrow indicates a transmission of power and data, the thin arrow indicates a transmission of data.

Electrical lines 40 are arranged in the hat rail 26 and are connected to an adapter that is configured as a supply module 16, the connection being accomplished using a T-connector, for supplying mains voltage. Supply module 16 is used for power supply to the electronic module 38 coupled therewith, and for feeding power into the bus.

The invention thus aims to transfer data and/or power between electronic modules 38 that are arranged adjacently on hat rail 26, at the same time enabling transfer of rather high powers.

Referring to FIGS. 3a, 3b, coil structures 22 in form of molded interconnect devices (MID) are provided at the inner faces of adjacent bus subscribers 12 (also referred to as “electronic component” below) in or on housings 18 of the electronic components, wherein a coil structure 22 preferably extends over the entire lateral face of the electronic component.

The opposing walls 20 and a high number of turns enable a transfer of large amounts of energy, or power. A transfer ratio between successive coils or bus subscribers can be adjusted through a ratio of turns of the coils 22. For example, the number of turns of a first coil 22 of an electronic component 12 is less than the number of turns of the coil arranged on the subsequent electronic component in the direction of energy transmission and facing the first coil 22. This permits to compensate for voltage losses in electronic component 12.

To compensate for losses along the bus, signal regeneration or amplification is suggested. For example, a circuit for amplifying signals or power is provided in supply module 16.

Radiation from the transmitter coil back into the electronics of the electronic component are reduced or completely suppressed by means of a foil having a metallic coating, which is disposed between the adapter and the electronic module.

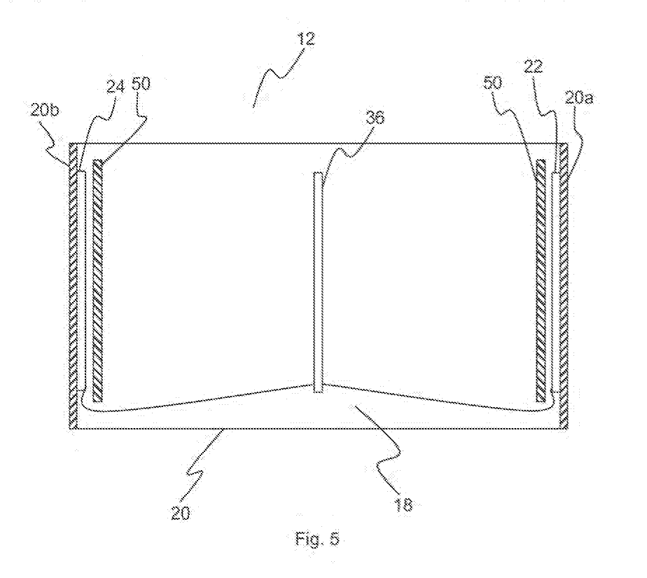

An exemplary bus subscriber 12 including a shielding 50 which at least reduces radiation from an antenna and hence crosstalk, is shown in FIG. 5 in cross section. Bus subscriber 12 in turn comprises a housing 18 of which only two opposing walls 20a and 20b and a bottom wall 20 are shown in FIG. 5. A respective antenna, 22 or 24, is disposed on the inner surface of each of walls 20a and 20b, which antennas may be in form of a coil. Moreover, a circuit board 36 having an electronic circuit is arranged within housing 18. Circuit board 36 is electrically connected to antennas 22 and 24. In order to prevent crosstalk between antennas 22 and 24, each antenna 22, 24 has arranged a plate-shaped shielding 50 in front thereof, which shielding preferably covers the entire antenna area. It is even conceivable to use the circuit board 36 itself as a shielding. For this purpose, the surfaces of circuit board 36 facing antennas 22 and 24 could be provided with a metallic layer.

In an alternative bus subscriber 12 (not shown), antennas 22 and 24 may be arranged on the respective outer surfaces of walls 20a and 20b. In this case, the inner surfaces of walls 20a and 20b may function as a shielding. For this purpose, a foil having a metallic coating could be applied as a shielding 50 at the respective inner surfaces of walls 20a and 20b, for example.

### REFERENCE NUMERALS

10 Bus system
12 Bus subscriber, electronic component
14 Adapter
16 Supply module
18 Housing
20 Wall
20a First wall, antenna wall
20b Second wall, antenna wall
22 Antenna, coil, coil structure
24 Further antenna
26 Support rail, hat rail
27 Fastening means of support rail
28 First fastening means
30 Second fastening means
32 Mains voltage
34 Galvanic connection
36 Electronic circuit
38 Electronic module
40 Electrical line
50 Shielding

What is claimed is:

1. A modular bus system for transferring data and/or power, comprising at least two bus subscribers that can be placed side by side, each bus subscriber comprising:
a housing having a plurality of walls;
at least one antenna arranged in or on a first wall of the housing, which antenna defines a geometrical antenna area which has a ratio to the surface area of the first wall of at least 0.5;
wherein the bus subscribers are electrically coupled to each other by having an antenna of each bus subscriber electromagnetically coupled to an antenna of another bus subscriber, for transferring data and/or power; and
wherein the first walls of bus subscribers that are electrically coupled to each other, are arranged approximately in parallel to each other.

2. The bus system as claimed in claim 1, characterized by at least one of the following features:
the bus system comprises a supply module for feeding electrical power and/or data, wherein the supply module is configured as a first bus subscriber;
the supply module comprises means for signal processing or signal amplification or signal regeneration;
the supply module is connected to a mains voltage which is preferably about 220 V or 110 V and has a frequency of about 50 Hz or 60 Hz.

3. The bus system as claimed in claim 1, characterized by at least one of the following features:
the antenna is in form of
a spiral antenna, circular antenna, coil, or capacitive plate; and/or
a molded interconnect device, or inlay; or
an overmolded antenna, or a thin wound antenna, or a printed antenna, or an adhesive antenna;
the antenna is disposed on a foil which is attached to the first wall.

4. The bus system as claimed in claim 1, characterized by at least one of the following features:
the area ratio has a minimum value of 0.5, or preferably 0.6, or in particular 0.7;
the antenna extends over the entire surface of the wall.

5. The bus system as claimed in claim 4, characterized by at least one of the following features:
the antenna of a bus subscriber has a number of turns that depends on the distance of the bus subscriber to the supply module, which distance is measured as a number of intermediary bus subscribers;
the antenna of a bus subscriber whose distance to the supply module is greater than the distance of a second bus subscriber to the supply module has a number of turns that is greater than the number of turns of the antenna of the second bus subscriber in order to compensate for losses, in particular transfer losses or losses in the electronic circuits of the bus subscribers.

6. The bus system as claimed in claim 1, characterized by at least one of the following features:
the housing of at least some of the bus subscribers has a further antenna arranged in a second wall thereof;
the first and/or second wall of the housing of at least some of the bus subscribers has a plurality of antennas arranged therein;
data and power can be transferred via different antennas;
data and power can be transferred via one antenna.

7. The bus system as claimed in claim 1, wherein each bus subscriber has an electronic circuit arranged in the housing thereof.

8. The bus system as claimed in claim 1, characterized by at least one of the following features:
each bus subscriber is configured in form of an adapter for being connected to an electronic module, each adapter being adapted for data and/or power transfer;
the adapter is adapted for being connected to a support rail and/or to the electronic module;
the adapter comprises a first fastening means for mechanical fixation to the support rail;
the adapter comprises a second fastening means for mechanical fixation to the electronic module;
the second fastening means imitates a shape of the support rail, so that the electronic module can be fixed to the adapter in a similar manner as to the support rail;
the electronic module can be coupled mechanically and/or electrically with the adapter by means of a plug-in connection, wherein the electrical coupling is preferably accomplished by terminal points;
the electronic module can be coupled electromagnetically with the adapter, for example inductively or capacitively, for data and/or power transfer;
the adapter comprises means for regenerating or amplifying an electrical signal, including a data signal and/or a power supply signal;
the adapter is electromagnetically shielded from the electronic module to prevent electromagnetic interference in the electronic module.

9. The bus system as claimed in claim 1, wherein the means for shielding the at least one antenna are arranged in the housing of at least one bus subscriber.

10. A bus subscriber for use in a modular bus system for data and/or power transfer, comprising:
a housing having a plurality of walls;
at least one antenna arranged in or on at least a first wall of the housing, which antenna defines a geometrical antenna area which has an area ratio to the surface area of the first wall of at least 0.5;
wherein the bus subscriber is adapted to be electrically coupled to at least one further bus subscriber by electromagnetically coupling an antenna of the bus subscriber with an antenna of the further bus subscriber, for transferring data and/or power; and
wherein the first walls of bus subscribers that are electrically coupled to each other, are arranged approximately in parallel to each other.

11. The bus subscriber as claimed in claim 10, which bus subscriber is configured as an adapter for being connected to an electronic module or as an electronic module.
